(19) United States
(12) Patent Application Publication
(10) Pub. No.: US 2013/0058830 A1
(43) Pub. Date: Mar. 7, 2013

(54) SENSOR SYSTEM USING A HOLLOW WAVEGUIDE

(71) Applicant: GEOISOCHEM CORPORATION, Covina, CA (US)

(72) Inventors: Sheng WU, San Gabriel, CA (US); Andrei DEEV, Pasadena, CA (US); Yongchun TANG, Walnut, CA (US)

(73) Assignee: GEOISOCHEM CORPORATION, Covina, CA (US)

(21) Appl. No.: 13/669,410

(22) Filed: Nov. 5, 2012

Related U.S. Application Data
(63) Continuation-in-part of application No. PCT/US2011/035080, filed on May 3, 2011.
(60) Provisional application No. 61/343,684, filed on May 3, 2010.

(51) Int. Cl. G01N 21/59; G01N 30/00; G06F 19/00

(52) U.S. Cl. 422/89; 356/437; 702/138; 702/116

(57) ABSTRACT

The present application provides a method for determining one or two parameters of a sensor system for detecting a gaseous sample. The sensor system comprises a light source to generate a light beam, a hollow waveguide to receive the light beam and the gaseous sample, and a detector to detect an absorption peak of the gaseous sample, where the length and inner diameter of the hollow waveguide satisfy relationships as disclosed herein.

### CROSS-REFERENCE TO RELATED APPLICATIONS

This application is a continuation in part of PCT/US2011/035080 filed on May 3, 2011, which claims the benefit of U.S. provisional application Ser. No. 61/343,684 filed on May 3, 2010.

### BACKGROUND

The idea of using hollow waveguide (HWG) as a sample cell for spectrometer has been around ever since HWG was first demonstrated. HWG is a capillary structure where both light and chemical samples could be guided and transported inside with minimal loss. Several papers (Sato, Saito et al. 1993; Worrell and Gallen 1997; Hvozdara, Gianordoli et al. 2000; Fetzer, Pittner et al. 2002; Charlton, Temelkuran et al. 2005; Young, Kim et al. 2009; Chen, Hangauer et al. 2010) already described conducting absorption spectroscopy under regular atmosphere pressure using HWG. In addition, U.S. Pat. No. 6,527,398 by Fetzer also disclosed a spectrometer integrating a laser and a hollow waveguide. But none of these disclosures considered conducting high resolution spectroscopy under slow continuous flow and/or very small volume samples. For advanced technologies such as gas chromatography (GC) and high-throughput combinatorial chemistry, there is need for methods and apparatus for conducting high resolution spectroscopy under slow continuous flow and/or small volume samples.

Operating HWG under lowered pressure, i.e. ˜30 Torr or 1/25th of an atmosphere, has also been demonstrated (Blake, Kelly et al. 2002), however, no flow rate is calculated or measured at such pressures. Although the author briefly mentioned the possibility of using HWG as a sensor for GC, the length of their HWG will be too long, i.e. >1.8 seconds, to have a reasonable response time for GC analysis. Application of HWG coupled with GC has also been demonstrated earlier by the inventors of the present application (Wu, S., et al., Hollow waveguide quantum cascade laser spectrometer as an online microliter sensor for gas chromatography. Journal of Chromatography A, 2008. 1188(2): p. 327-330.), but only under regular pressure of the capillary GC system, i.e. slightly above 1 atmospheric pressure, and resolution is limited to 0.1 cm⁻¹.

There is tremendous progress recently in semiconductor lasers operating in the Mid-Infrared region, i.e. 2-20 μm, which is important for chemical sensing. Therefore, there is the great interest to develop spectroscopy sensing platforms that could maximize the advantage of such lasers.

### SUMMARY

In one aspect, the present application relates to a laser spectrometer, and in particular an infrared laser spectrometer using hollow waveguide to conduct absorption spectroscopy on samples with small volume and/or slow continuous flow rate.

The absorption (or optical absorption) of species in a sample (or a gaseous analyte) may be measured, and the concentration of the species inside the HWG may be calculated using Beer's law.

Species contained in a sample (a gaseous analyte or gaseous analytes) may be molecules, atoms, and isotope species of the same molecule. If a sample contains two isotope species, the isotope ratio may be calculated by measuring the ratio of the concentration of the two isotope species.

In certain embodiments, a gaseous analyte is selected from CO₂, H₂O, and a mixture thereof. The isotopic species of element carbon (C) include ¹¹C, ¹²C, ¹³C, and ¹⁴C, preferably ¹²C and ¹³C. The ratio of ¹²C vs. ¹³C in a sample or a gaseous analyte is measured. In certain embodiments, the isotopic species of element hydrogen (H) include ¹H (proton) and ²H (deuterium), whereas the ratio of ¹H vs. ²H in a sample or a gaseous analyte is measured.

In another aspect, the present invention relates to an analytical system comprising a gas chromatograph and a laser spectrometer of the present application which could be used to optically detect eluted chemical compounds or gaseous analyte(s).

In another aspect, the present application relates to a method for determining isotope ratio of chemical compounds in mixtures after chromatographic separation.

In one aspect of the present application, a sensor system for detecting a gaseous sample or a gaseous analyte is provided. The sensor system comprises: a light source to generate a light beam, a hollow waveguide which transmits the light beam and has a gas inlet and a gas outlet, wherein the gaseous analyte is introduced into the hollow waveguide through the gas inlet under an inlet pressure (P) and elutes through the gas outlet with a outlet pressure (Pₒᵤₜ, Pₒᵤₜ<P) which creates a pressure difference δp (δp=P−Pₒᵤₜ); and a detector which detects an absorption peak of the gaseous analyte crossing the hollow waveguide in the presence of the light beam during transmitting; where the hollow waveguide has a length (L) and an inner diameter (D), where L and D substantially satisfy equation A and equation B,

$$\begin{matrix}\frac{L}{{D}^{4}} = \frac{P \cdot δ p \cdot π}{T \cdot μ \cdot Q \cdot {Z}_{m} \cdot R \cdot 128} & ( equation A ) \\ L \cdot {D}^{2} = \frac{Q \cdot t \cdot R \cdot T}{P} & ( equation B )\end{matrix}$$

where P is the pressure at the inlet of the hollow waveguide which is about 10 Torr to about 200 Torr, by is the pressure difference between the inlet and the outlet of the hollow waveguide which is about 0.1% to about 60% of P (or about 1% to about 60% of P, about 2% to 60% of P, or about 3% to 60% of P, of about 5% to 60% of P), t is the response time of the hollow waveguide, T is the temperature of the gaseous analyte in the hollow waveguide, μ is the viscosity of the gaseous analyte, Q is the mole flow rate of the gaseous analyte (mole/sec, or equivalent to 2,240 Pa*m3/sec at standard temperature of 273.15 Kelvin), Zₘ is the compressibility of the gaseous analyte, R is the ideal gas constant equals to 8.31 Joule/Kelvin/Mole.

In some embodiments, the light source is a laser source.

In some embodiments, the laser source is a semiconductor laser source.

In some embodiments, the semiconductor laser source is selected from quantum cascade laser sources and diode laser sources.

In some embodiments, the light beam is electromagnetic radiation with a wavelength in the Mid-Infrared region, i.e. within the range of about 2 to about 50 μm, or about 2 to about 40 μm, or about 2 to about 20 μm, about 2 to about 10 μm, about 2 to about 8 μm, or about 3 to about 20 μm, or about 3 to about 10 μm, or about 3 to about 8 μm.

In some embodiments, the sensor system comprises a GC connected with the hollow waveguide, where during detection, the gaseous sample is first separated by the GC, and then is sent into the hollow waveguide.

In some embodiments, Q is determined according to the output volumetric flow rate of the GC.

In some embodiments, Q is a value within the range of Q_{GC}*70%˜Q_{GC}*130%, where Q_{GC} is the output volumetric flow rate of the GC.

In some embodiments, t is determined according to intervals between pulses output by the GC.

In some embodiments, the sensor system comprises a control loop for keeping P and Q stable.

In some embodiments, the sensor system comprises a combustion or pyrolysis reactor connected with the inlet of the hollow waveguide, where the combustion or pyrolysis reactor converts the gaseous sample into smaller molecules. For example, hydrocarbons and other organic molecules can be combusted or converted into CO₂ and/or H₂O as gaseous analytes to be introduced into the hollow waveguide.

In some embodiments, the sensor system comprises a temperature controlling device for keeping the temperature of the hollow waveguide stable using a feedback close loop mechanism.

In some embodiments, the sensor system comprises a light splitter which splits from the light beam a second light beam, and a second detector to which the second light beam is directed, where the signal detected by the second detector is used to cancel noises resulted from fluctuation of the power of the light beam.

In another aspect, the present application provides a sensor system for detecting at least one gaseous analyte with high resolution. The sensor system comprises: means for generating a light beam, means for transmitting the light beam and the gaseous analyte with a gas inlet and a gas outlet, means for applying a low pressure (P) to the gaseous analyte at the gas inlet, means for generating a pressure difference between the gas inlet and the gas outlet wherein the pressure at the gas outlet is lower than P, and means for detecting an absorption peak of the gaseous analyte in the presence of the light beam during transmitting, where means for transmitting the light beam and the gaseous analyte has a length (L) and an inner diameter (D), where L and D substantially satisfy equation A and equation B,

$$\begin{matrix}\frac{L}{{D}^{4}} = \frac{P \cdot δ p \cdot π}{T \cdot μ \cdot Q \cdot {Z}_{m} \cdot R \cdot 128} & ( equation A ) \\ L \cdot {D}^{2} = \frac{Q \cdot t \cdot R \cdot T}{P} & ( equation B )\end{matrix}$$

where P is the pressure applied for transmitting the gaseous analyte at the inlet which is about 10 Torr to 200 Torr, by is the pressure difference between the gas inlet and the gas outlet which is about 0.1%˜60% of P (preferably about 1% to about 60% of P), t is the response time of the means for transmitting the gaseous analyte, T is the temperature of the gaseous analyte in the hollow waveguide, μ is the viscosity of the gaseous analyte, Q is the mole flow rate of the gaseous analyte, Zₘ is the compressibility of the gaseous analyte, R is the ideal gas constant equals to 8.31 Joule/Kelvin/Mole.

In another aspect, the present application provides a method for detecting a gaseous analyte (or an isotopes or a first isotope and a second isotope and the ratios between the two) with high resolution. The method comprises: transmitting a light beam to a hollow waveguide having a gas inlet and a gas outlet; introducing the gaseous analyte into the hollow waveguide through the gas inlet; generating a pressure difference (δp) between a first pressure at the gas inlet (P) and a second pressure at the gas outlet (Pₒᵤₜ, wherein Pₒᵤₜ<P and δp>0) and detecting an absorption peak of the gaseous analyte, where the hollow waveguide has a length (L) and an inner diameter (D), where L and D satisfy equation A and equation B,

$$\begin{matrix}\frac{L}{{D}^{4}} = \frac{P \cdot δ p \cdot π}{T \cdot μ \cdot Q \cdot {Z}_{m} \cdot R \cdot 128} & ( equation A ) \\ L \cdot {D}^{2} = \frac{Q \cdot t \cdot R \cdot T}{P} & ( equation B )\end{matrix}$$

where P is the pressure at the inlet of the hollow waveguide which is about 10 to 200 Torr, δp by is the pressure difference between the inlet and the outlet of the hollow waveguide which is about 0.1% to about 60% of P, t is the response time of the hollow waveguide, T is the temperature of the gaseous analyte in the hollow waveguide, μ is the viscosity of the gaseous analyte, Q is the mole flow rate of the gaseous analyte, Zₘ is the compressibility of the gaseous analyte, R is the ideal gas constant equals to 8.31 Joule/Kelvin/Mole.

In another aspect, the present application provides a method for determining length L and inside diameter D of a hollow waveguide of a sensor system for detecting a gaseous sample. The hollow waveguide is to receive the gaseous sample and a light beam. The sensor system further comprises a light source to generate the light beam, and a detector to detect an absorption peak of the gaseous sample. The method comprises: determining maximum and minimum values of the pressure at the entrance of the hollow waveguide P, the mole flow rate of the gaseous sample Q, the pressure difference between the entrance and the exit of the hollow waveguide δp, the response time of the hollow waveguide t, and the temperature of the gaseous sample T; calculating a maximum and a minimum values for L/D⁴ which are indicated as V_{LD1} and V_{LD2}, respectively, using the determined maximum and minimum values according to the equation:

$$\frac{L}{{D}^{4}} = \frac{P \cdot δ p \cdot π}{T \cdot μ \cdot Q \cdot {Z}_{m} \cdot R \cdot 128} and L \cdot {D}^{2} = \frac{Q \cdot t \cdot R \cdot T}{P} ,$$

calculating a maximum and a minimum values for L*D² which are indicated as V_{LD3} and V_{LD4}, respectively, using the determined maximum and minimum values according to the equation

$$L \cdot {D}^{2} = \frac{Q \cdot t \cdot R \cdot T}{P}$$

; and
selecting a point substantially falls in an area surrounded by four lines defined by equations L/D⁴=V_{LD1}, L/D⁴=V_{LD2}, L*D²=V_{LD3}, and L*D²=V_{LD4}, respectively,
where μ is the viscosity of the gaseous sample, Zₘ is the compressibility of the gaseous sample, R is the ideal gas constant equals to 8.31 Joule/Kelvin/Mole.

In another aspect, the present application provides a computer program comprising computer executable instructions when executed by a computer instruct the computer to conduct the above method.

In another aspect, the present application provides a computer readable medium containing the above computer program.

In another aspect, the present application provides a method for determining one or two parameters of a sensor system for detecting a gaseous sample. The sensor system comprises a light source to generate a light beam, a hollow waveguide to receive the light beam and the gaseous sample, and a detector to detect the light signal output by the hollow waveguide. The method comprises: determining maximum and minimum values of the other parameters of the sensor systems, determining a range of the one or two parameters using the determined maximum and minimum values and equations:

$$\frac{L}{{D}^{4}} = \frac{P \cdot δ p \cdot π}{T \cdot μ \cdot Q \cdot {Z}_{m} \cdot R \cdot 128} and L \cdot {D}^{2} = \frac{Q \cdot t \cdot R \cdot T}{P} ,$$

and selecting a value for each of the one or two parameters in the determined range.

In another aspect, the present application provides a sensor system for detecting a gaseous sample. The sensor system comprises: a light source to generate a light beam, a hollow waveguide to receive the light beam and the gaseous sample, and a detector to detect an absorption peak of the gaseous sample, where the hollow waveguide has a length L and an inside diameter D, where L and D fall in an area surrounded by four lines defined by the following four equations, respectively,

L/D⁴=V_{LD1}

L/D⁴=V_{LD2}

L*D²=V_{LD3}

L*D²=V_{LD4}

where V_{LD1} and V_{LD2} are maximum and minimum values of

$$\frac{P \cdot δ p \cdot π}{T \cdot μ \cdot Q \cdot {Z}_{m} \cdot R \cdot 128}$$

calculated using predetermined maximum and minimum values of P, δp, T, and Q, where P is the pressure of the entrance of the hollow waveguide, δp by is the pressure difference between the entrance and the exit of the hollow waveguide, T is temperature of the gaseous sample in the hollow waveguide, μ is the viscosity of the gaseous sample, Q is the flow rate of the gaseous sample, Zₘ is the compressibility of the gas sample, R is the ideal gas constant equals to 8.31 Joule/Kelvin/Mole.
where V_{LD3} and V_{LD4} are maximum and minimum values of

$$\frac{Q \cdot t \cdot R \cdot T}{P}$$

calculated using the predetermined maximum and minimum values of P and Q and predetermined maximum and minimum values of t, where t is the response time of the hollow waveguide.

In one embodiment, the maximum value of P may be in the range of 60˜150 torr, and the minimum value of P may be in the range of 5˜50 torr.

In some embodiments, T may be set a single fixed value at which the detection will be performed. In some embodiments, the maximum value of T may be the highest temperature at which the detection can be performed, and the minimum value of T may be the lowest temperature at which the detection can be performed. The maximum value and the minimum value of T may be set according to specific conditions, for example, T is set at as room temperature since it could be kept constant at room temperature relatively easier.

### BRIEF DESCRIPTION OF THE DRAWINGS

The accompanying drawings are included to provide a further understanding of the present application and are incorporated in and constitute a part of this specification. The drawings illustrate the embodiments of the present application and together with the description serve to explain the principles of the application. Other embodiments of the present application and many of the intended advantages of the present application will be readily appreciated, as they become better understood by reference to the following detailed description. The elements of the drawings are not necessarily to scale relative to each other. Like reference numerals designate corresponding similar parts.

FIG. 1 illustrates exemplary plots of an area of L and D according to one embodiment of the present application.

FIG. 2 illustrates a schematic diagram of a sensor system according to one embodiment of the present application.

FIG. 3 illustrates a schematic diagram of a sensor system according to one embodiment of the present application.

FIG. 4 illustrates a schematic diagram of a method for determining L and D of a hollow waveguide of a sensor system according to one embodiment of the present application.

FIG. 5 illustrates a schematic diagram of a method for determining a range of one or two parameters of a sensor system according to one embodiment of the present application.

FIG. 6 illustrates a schematic diagram of a computer system according to one embodiment of the present application.

FIG. 7 illustrates the high resolution scan under low pressure using the sensor system disclosed herein versus low resolution sensor at 1 Atmospheric pressure. There is an overlap of the two spectral features in the low resolution scan system and interference between the two species could not be removed, resulting a poor performance of the low resolution sensor system.

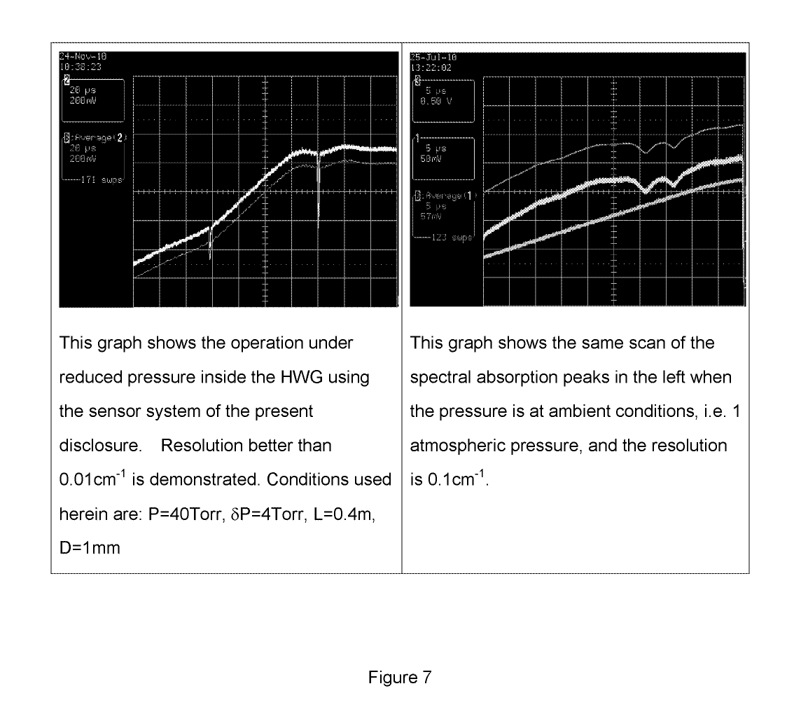

### DETAILED DESCRIPTION OF ILLUSTRATED EMBODIMENTS

In the following detailed description, reference is made to various specific embodiments of the invention. These embodiments are described with sufficient detail to enable those skilled in the art to understand the application. It is to be understood that other embodiments may be employed, and that various changes may be made without departing from the spirit or scope of the application. In describing the preferred embodiments, specific terminology will be resorted to for the sake of clarity. However, it is not intended that the application be limited to the specific terms so selected and it is to be understood that each specific term includes all technical equivalents which operate in a similar manner to accomplish a similar purpose. For example, the word connected or terms similar thereto are often used. They are not limited to direct connection but include connection through other element where such connection is needed.

Compound specific measurements of isotope ratios in mixtures require initial chromatographic separation of species before performing isotope analysis. Currently, such measurements are performed by an isotope ratio mass-spectrometer (IRMS) coupled with a gas chromatograph (GC) and a combustion or pyrolysis module. Isotope ratio mass-spectrometers are sophisticated, delicate and expensive instruments. They utilize a magnetic sector for mass separation, and therefore, are very sensitive to vibrations and power line voltage fluctuations. These drawbacks prevent them from being used in the field. It has been shown by many research groups that optical spectroscopy with the latest Mid-Infrared laser technologies can be used for measurement of isotope ratio of small molecules, e.g. CO₂ and CH₄, with an accuracy equal or exceeding that of IRMS (Tuzson, B., et al., Quantum cascade laser based spectrometer for in situ stable carbon dioxide isotope measurements. Infrared Physics & Technology, 2008. 51: p. 198-206.).

Optical isotope ratio spectrometers are significantly less expensive, more robust than IRMSs, and have been successfully deployed in the field. However, in order to utilize optical spectroscopy to perform compound specific isotope ratio measurements, a laser spectrometer also needs to be integrated with a gas chromatograph. The amount of sample that can be separate in a GC in a single run depends on the column size and flow rate, and typically varies between tens and hundreds of microliters. Therefore, in order to achieve the maximum sensitivity of optical detection in compound specific isotope ratio applications, it is necessary to optimize the laser spectrometer for the small sample volume size produce by GC.

Optical methods for measuring isotope ratios of larger molecules, e.g. hydrocarbons, have been demonstrated with (Zare, R. N., et al., High-precision optical measurements of C-13/C-12 isotope ratios in organic compounds at natural abundance. Proceedings of the National Academy of Sciences of the United States of America, 2009. 106(27): p. 10928-10932.) or without (U.S. Pat. No. 7,063,667 by Ben-Oren et. al.) coupling to GC, but none of them uses HWG.

In one embodiment, a hollow waveguide (HWG) is used as a sample cell for sensing. Using a HWG as a small sample volume cell for absorption spectroscopy sensing under a pressure same to or higher than ambient, i.e. one atmosphere, has already been demonstrated before (Sato, Saito et al. 1993; Worrell and Gallen 1997; Hvozdara, Gianordoli et al. 2000; Fetzer, Pittner et al. 2002; Charlton, Temelkuran et al. 2005; Young, Kim et al. 2009; Chen, Hangauer et al. 2010). But to achieve high resolution, one can lower the pressure of the sample inside to a fraction of an atmosphere. The relationship between the linewidth (Δv) of the absorption spectroscopic feature and the pressure of the gas sample (P) is as follows:

Δv=P*A (Equation 1)

Where A is a value that varies with gas molecules, and usually it is about 4 MHz/Torr. That means the linewidth of the spectroscopic feature is about 3 GHz at 1 atmosphere, or about 0.1 cm⁻¹. Intuitively, measurement performed under lower pressure will have a linewidth much smaller, and is limited by the Doppler broadening of the molecules which is given by:

$$FWHM ( Δ {\tilde{v}}_{D} ) = {\tilde{v}}_{0} \sqrt{\frac{8 kTln 2}{{mc}^{2}}} = {\tilde{v}}_{0} ( 7.1623 \times {10}^{- 7} ) \sqrt{\frac{T}{M}} \qquad ( Equation 2 )$$

Where T is temperature (Kelvin), and M is molecular weight (molar mass, grams/mole). This gives linewidth Δv_{D} of the spectroscopic feature (full width at half-maximum) about 0.003 cm⁻¹ for CO₂ detected at 2,300 cm⁻¹. Therefore, it is preferred to reduce the pressure of the HWG cell to a value such that pressure broadening is close to the Doppler linewidth, to achieve highest signal to noise ratio and remove interferences from other spectra peaks.

In the sensor system with HWG described above, it is preferred that the temperature of the HWG is tightly controlled. In absorption spectroscopy, the absorption line intensities depend strongly on temperature following the Boltzmann distribution,

$$\frac{{n}_{j}}{N} = \frac{exp ( - {ɛ}_{j} / kT )}{{\sum }_{i} exp ( - {ɛ}_{i} / kT )} , and N = {\sum }_{i} {n}_{i}$$

where nⱼ is proportional to line intensity of the energy level εⱼ, N is the total number of molecules in the sample, T is the temperature of the sample, and k is the Boltzmann constant.

Therefore, it is important to keep the temperature accurately and stably over the time of measurement. This is especially true for isotopic measurement, where the choice of two lines for the isotopic isomers often have large temperature dependence. In some embodiments, it is preferred to keep the temperature fluctuations under 10 mKelvin in order to achieve the accuracy desired. Therefore, specific designs that could keep the temperature of the HWG with fluctuations under 1 mK may be provided.

It is known that under limited lowered pressure, there will be a restriction of sample volume or flow rate for this kind of sensing cell. Chemical analysis is a routine method in many areas of science and often, the amount of sample available for analysis in the detector is limited and the response time of the sensor for a fast changing sample input is preferably small. Therefore, it is preferable for many applications to optimize the sensor for small sample volume. Following a guideline provided here, a desired lower pressure across the length of the HWG, along with a desired response time with a limited amount of sample volume or low flow rate can be achieved.

In one embodiment, the relationship and parameters used for characterizing a sensor system are given below:

$$\begin{matrix}\frac{L}{{D}^{4}} = \frac{P \cdot δ p \cdot π}{T \cdot μ \cdot Q \cdot {Z}_{m} \cdot R \cdot 128} & ( equation 3 ) \\ L \cdot {D}^{2} = \frac{Q \cdot t \cdot R \cdot T}{P} & ( equation 4 )\end{matrix}$$

where T is temperature (Kelvin) in the hollow waveguide, P is the pressure of the sample at the entrance of the HWG, δp is the pressure difference between the sample entrance and the exit of the HWG (pascal), μ is the viscosity of the gas sample (10⁻⁶ pascal/Sec), Q is the mole flow rate of the sample input into the HWG under standard atmospheric pressure (mol/min), Zₘ is the compressibility of the gas sample, R is the ideal gas constant of 8.31 Joule/Kelvin/Mole, L is the length of the HWG (mm), and D is the diameter of the HWG (mm), and t is the response time of the HWG (second).

In some embodiments, in equations 3 and/or 4, an expression on one side of the equality sign is not exactly equal to the expression on the other side. In some embodiments, the difference between two expressions on different sides is within 5%. In some embodiments, the difference is within 3%. In some embodiments, the difference is within 2%.

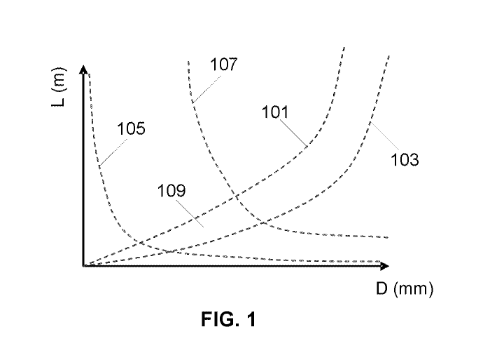

In one embodiment, in designing a sensor system based on HWG for high resolution absorption spectroscopy, the pressure applied at the gas inlet (or entrance) of HWG (P) is provided to a gaseous analyte or sample being introduced to HWG at, i.e. 10 Torr<P<100 Torr for the Mid-IR range light beam, and the pressure difference (5p)between the entrance and the exit (the gas outlet of HWG) is generated having about, i.e. 50% of P, and the flow rate Q is set to or provided at certain maximum and minimal values. Thus, at a given temperature (T) and sample (μ), referring to FIG. 1, we will have a line 101 with the maximum L/D⁴ value and a line 103 with the minimal L/D⁴ value. The slopes of lines 101 and 103 are decided by the chosen pressure, pressure difference and flow rate at a given temperature and sample gas type.

In the meantime, the response time t is set or provide in a certain range, for example, set the maximum value of the response time t such that response is fast enough (t<about 2 s, or t<about 1.5 s, or t<about 1 s). Thus, at a given temperature (T), referring to FIG. 1, we will have a line 105 with the maximum LD² value and a line 107 with the minimal LD² value.

Apparently, the acceptable values of L and D, which meet the requirements defined by both equation 3 and equation 4, substantially fall inside the area 109 surrounded by the lines 101, 103, 105, and 107. As mentioned above, there may be a minor difference between the two expressions on different sides of an equality sign. “L and D substantially satisfy the equations 3 and 4” means the difference between two expressions on different side of an equality sign is within an acceptable range, such as 5%, or 3%, or 2% as mentioned above.

In some embodiments, after the area 109 is determined, one may choose a point substantially falls in the area 109 for a desired value of a parameter. For example, to achieve a relatively short response time, one may choose the point of intersection of the lines 103 and 107.

In one embodiment, if a sensor system of the present application is used with a GC, the maximum and the minimum values of Q may be determined according to the output volumetric flow rate of the GC. For example, if the output flow rate of the GC is 1 ml/second±1% (STP, standard pressure and temperature), then the maximum value of Q may be set 1.3/2,240 mole/second, and the minimum value of Q may be set 0.7/2,240 mole/second.

In some embodiments, T is less than 200° C. In some embodiments, T is within the range of 40˜100° C.

In one embodiment, a maximum value of P may be calculated based on an acceptable spectra resolution to achieve the spectra resolution. In one embodiment, the maximum value of P may be set 200 torr, 150 torr, 130 torr, 120 torr, 110 torr, 100 torr, 90 torr, 80 torr, 70 torr, 60 torr, 50 torr, 40 torr, 30 torr, 20 torr, 10 torr, or any point falls in the range of 10˜200 torr, preferably the range of 10˜100 torr. In some embodiments, the maximum value of P is preferably 110 torr, and more preferably 100 torr. A too low P may result in drop of absorption intensity, therefore a minimum value of P may be set according to an acceptable absorption intensity. In one embodiment, the minimum value of P may be set 50 torr, 40 torr, 30 torr, 20 torr, 10 torr, 5 torr, or any point falls in the range of 5˜50 torr. In some embodiments, the minimum value of P is preferably 20 torr, and more preferably 10 torr.

In one embodiment, a maximum value of response time t may be determined according to an acceptable detecting accuracy. For example, to make the pulses in the gas sample highly resolved, the duration of a pulse or a peak may be set such a number that the intervals between the pulses is 3, or 4, or 5 or a higher number of times of the pulse duration. Then the maximum value of t may be set a N^{th} of the duration. In some embodiments where a GC is utilized in the sensor system, N may be called “minimum number of data points for a GC elute peak”. In many practical GCs, the response time is preferably less than or equal to about 1 s, or less than or equal to about 0.5 s, preferably less than or equal to about 0.25 s, or 4 Hz, to qualify as a good detector that will generate uncompromised GC peak resolution. Compared with a low enough value, contribution to accuracy of a t lower than the value will be limited, therefore a minimum value of t may be set according to the value.

A too high δp will cause degradation of a sensor system's sensitivity, therefore a maximum value of δp may be determined according to an acceptable sensitivity. For example, the maximum value of by may be set about 60%, or 50%, or 40%, or 30%, or any number in the range of about 30˜60% of P. A minimum value of by may be set according to best performance of available HWG or estimation, for example, the minimum value of by may be set about 0.1%, 0.5%, 1%, 2%, 3%, 4%, 5%, 6% 7%, 8%, 9%,10%, or 20%, or 30%, or any number in the range of 1˜30% of P.

For many applications, the typical sample flow rate into the HWG sensor is from 0.5˜10 ml/min, and achievable response time is from 0.05˜10 seconds. Thus, it is preferred that the Inside Diameter D of the HWG is over 0.75 mm, but same as or less than the practical limit of present available HWG, i.e. 1.0 mm. The choice of the length of the HWG could be made following the desired response time, and based on calculation and experiments. In some embodiments, it is found that it is preferred that the length of the HWG is less than 2 meters if the response time is less than 1 second, and the length of the HWG is less than 4 meters if the response time is less than 2 seconds.

It will be appreciated by those skilled in the art that there are many other modes for setting P, δp, and Q. For example, P may be given a single fixed value, Op may be given a maximum value and a minimal value, and Q may be given a maximum value and a minimal value. In another example, P may be given may be given a maximum value and a minimal value, by may be given a maximum value and a minimal value, and Q may be given a maximum value and a minimal value. In another example, P may be given may be given a maximum value and a minimal value, by may be given a single fixed value, and Q may be given a maximum value and a minimal value. Any combination may be used based on specific conditions and/or requirements.

It will be appreciated by those skilled in the art that besides L and D, other parameters may also be optimized using equations 3 and 4. For example, D is set a fixed value, a maximum and a minimum values of Q are determined, and a maximum and a minimum values of by are determined, a maximum and a minimum values of L*P indicated as V_{LP1} and V_{LP2}, respectively, and a maximum and a minimum values of L/P indicated as V_{LP3} and V_{LP4}, respectively, may be calculated. Therefore, L and P that meet the requirement fall in an area surround by the lines defined by L*P=V_{LP1}, L*P=V_{LP2}, L/P=V_{LP3}, L/P=V_{LP4}, respectively.

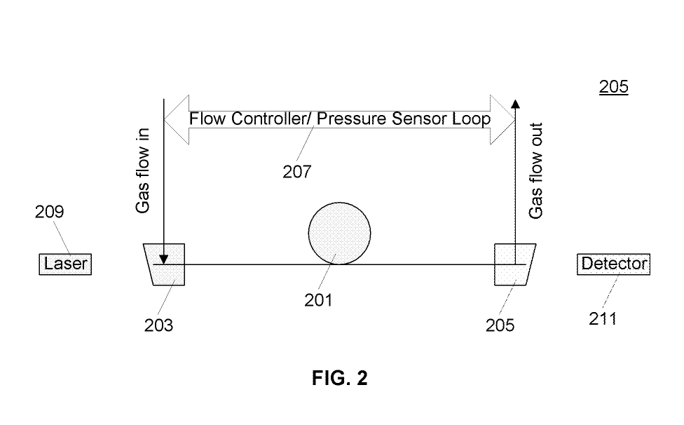

FIG. 2 illustrates a schematic diagram of a sensor system 200 according to an embodiment of the present application. The sensor system 200 includes a hollow waveguide 201, couplers 203 and 205, a flow controller/pressure sensor loop 207, a laser source 209, and a detector 211.

The hollow waveguide 201 is connected with input and output lines for transporting samples via couplers 203 and 205 designed to minimize dead volume and, therefore, improve the response time of the system. The length L and inside diameter D of the hollow waveguide 201 substantially fall in the area 109.

An optical beam from the laser source 209 is collimated with certain lens(es) or mirror(s), or any combination thereof, and is directed into the hollow waveguide 201.

The couplers 203 and 205 have windows transparent to optical radiation in desired operating ranges.

The pressure and pressure drop along the waveguide are maintained constant by the flow controller/pressure sensor loop 207, which could be a combination of a pressure sensor, electrically actuated valves and an electronic or computer control loop.

The detector 211 detects the optical signal output by the waveguide 201 for later determination of what is contained in the sample.

As an example, the HWG can be supplied by Polymicro Inc. (Phoenix, Ariz, USA), the detector can be supplied by VIGO (Poland) and Mid-IR semiconductor lasers could be supplied by Alpes Lasers (Switzerland), the pressure sensors and flow controllers can be supplied by MKS Instrument (MA, USA) and other vendors or customer may build with similar functions. The GC can be supplied by vendors like Agilent Technology (CA, USA), Thermo Scientific (MA, USA), and other vendors or customer may build with similar functions.

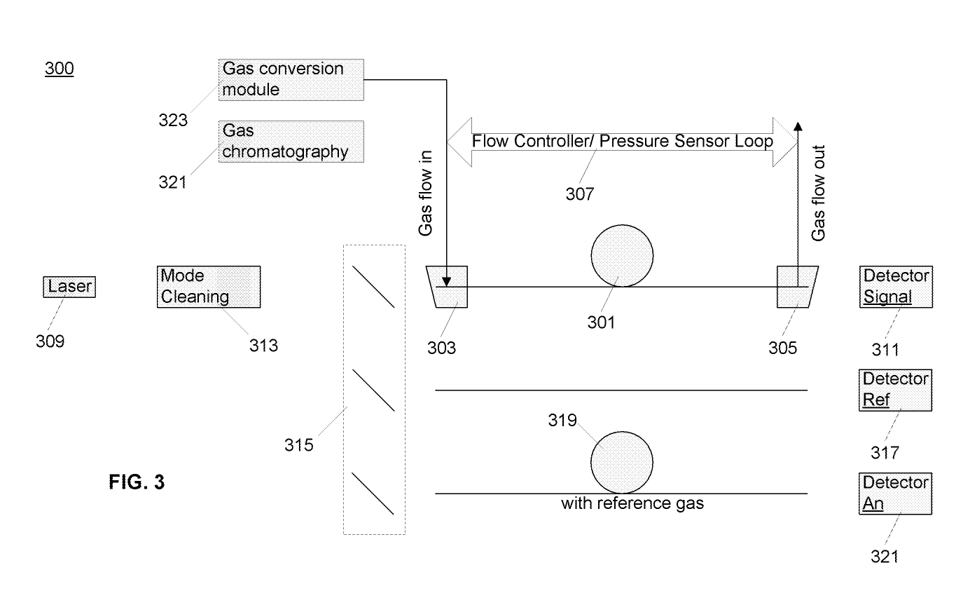

FIG. 3 illustrates a schematic diagram of a sensor system 300 according to an embodiment of the present application. The sensor system 300 includes a hollow waveguide 301, couplers 303 and 305, a flow controller/pressure sensor loop 307, a laser source 309, and a detector 311, where the length L and inside diameter D of the hollow waveguide 301 substantially fall in the area 109.

The sensor system 300 optionally includes a mode cleaning device 313 for filtering out laser radiation of high-order spatial modes. Such a device may consist of a several lens and filtering apertures.

To that only lowest order mode, i.e. He10, is coupled into the hollow waveguide, mode cleanup methods including use of relay imaging techniques, as well as passing through another hollow waveguide which only transmit low order mode may be used. Methods to keep the lowest order mode of the laser inside the hollow waveguide include keeping the hollow waveguide straight and careful designing couplers to avoid deformation which is known to cause higher order modes.

The sensor system 300 optionally includes a beam splitter 315 which splits the beam from the laser source 309 into two beams, one is directed into the hollow waveguide 301 and then to the detector 311, the other is directed to a reference signal detector 317. The power of the laser beam from the laser source 309 may vary with time during the course of detection, and this will cause noise and a slope in the signal detected by the detector 311 thus affects the performance of the sensor system 300, the signal detected by the detector 317 can be used to cancel the noise and the slope in the signal detected by the detector 311.

The sensor system 300 optionally includes an optical gas cell or a second hollow waveguide 319 containing a reference gas therein, and a analytical reference signal detector 321, and optionally a third laser beam is split by the beam splitter 315 from the laser source 309 and is directed into the optical gas cell or hollow waveguide 319 and then to the analytical reference signal detector 321. Wavelength scanning speed of the beam from the laser source 309 may vary with time during the course of detection, for example, at t₀ wavelength scanning speed is 100 nm/s and at t1 wavelength scanning speed is 100.1 nm/s, thus affects the wavelength stability/frequency stability, and this will shift the original point of a peak obtained using the signal detected by the detector 311. To obtain a relatively accurate original point of the peak, the signal detected by the detector 321 is used to find the relatively accurate original point of the peak. In some embodiments, the temperature and/or the pressure of the reference gas in the optical gas cell or the hollow waveguide 319 are optionally kept the same as that of the gaseous sample. In some embodiments, the reference gas has the same compositions as that of the gaseous sample and known concentration.

The sensor system 300 optionally includes a gas chromatograph (GC) 321 and a gas conversion module 323. The gas conversion module 323 may be a combustion or pyrolysis chemical reactor, which converts gas packets of complex chemical compounds in smaller, easy-to-detect molecules, for example, carbon dioxide and water. The gaseous sample is sent to the GC 321 for separation first, and then the separated gaseous sample is passed through the gas conversion module 323, and the products of chemical conversion pass through the hollow waveguide, where their concentration and/or isotope ratio is measured spectroscopically.

In some embodiments, the volumetric flow rate of the gaseous sample flow through the hollow waveguide 301 is the same as the volumetric flow rate of the gaseous sample output by the GC 321.

In one embodiment, a hollow waveguide was integrated with a gas chromatograph (514). A gas mixture injected into the chromatograph was separated into several gas packets corresponding to the components of the mixture. All the gas packets of different compounds were subsequently converted to a one type of analytes or species, for example, CO₂ or H₂O, via combustion, high-temperature conversion or another chemical process. The concentration and isotope content of the resultant species was then analyzed by a detector system disclosed herein. In this embodiment the flow rate through the low-volume flow cell or hollow waveguide was selected to match the linear velocity of the flow in the chromatography column in order to avoid broadening of chromatographic peaks. In this application of capillary GC coupled with HWG, the sample flow rate (volumetric at standard atmosphere pressure) was about 0.5˜5 ml/minute, if a response time was desired to be better than 2 seconds, HWG inside diameter was no less than 750 μm, but no more than 2.0 mm; while the length of the HWG was between 200 mm and 3 meters (e.g., 250 mm to 5 meter)

One set of value for sample gas where He is the carrier gas at 313 Kelvin:

| D | L | p | δp | μ | Q | t |
|---|---|---|---|---|---|---|
| 1 mm | 500 mm | 4750 Pa | 250 Pa | 20.68 μPa/S | 1.5 (ml/min) | 0.7 (S) |

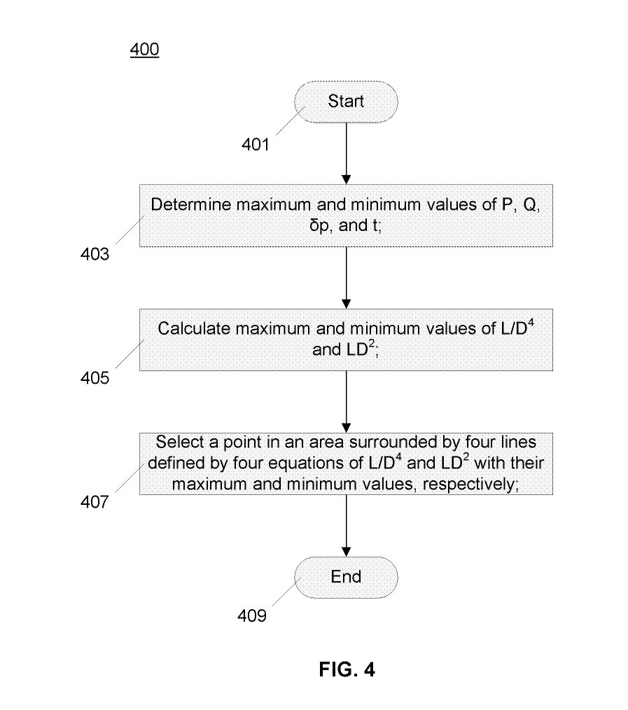

FIG. 4 illustrates a schematic diagram of a method 400 for determining length L and inside diameter D of a hollow waveguide of a sensor system for detecting a gaseous sample.

In block 401, the method 400 starts.

In block 403, determine maximum and minimum values of P, Q, δp, and t. Some embodiments of determining the maximum and minimum values of P, Q, δp, and t has been discussed above.

In block 405, calculate maximum and minimum values of L/D⁴ and LD². In this step, calculate the maximum and minimum values V_{LP3} and V_{LP4} of L/D⁴ using the maximum and minimum values of P, Q, and δp according to equation 3. Calculate the maximum and minimum values V_{LP1} and V_{LP2} of L*D² using the maximum and minimum values of P, Q, and t according to equation 4.

In block 407, select a point in an area surrounded by four lines defined by four equations of L/D⁴ and LD² with their maximum and minimum values, respectively. In this step, four equations L*P²=V_{LP1}, L*P²=V_{LP2}, L/P⁴=V_{LP3}, and L/P⁴=V_{LP4} are obtained, and thus the area surrounded by the four lines defined by the four equations is obtained. Any point falls in the area meets the requirements. In some embodiments, one may select a point in the area based on available values of D and related parameters. For example, select 0.75 mm for D, and select a minimum value of L along the straight line D=0.75 mm in the area to obtain a maximum value of t that meets the requirements.

In block 409, the method 400 ends.

Determining maximum and minimum values of T, Q, P, δp, and t means determining maximum and minimum values of at least one of the parameters, and determining a single fixed value for each of other parameters. For example, in one embodiment, one may determine maximum and minimum values for each of the parameters. In another embodiment, one may determine maximum and minimum values for only one of the parameters, and determine a single fixed value for the rest parameters.

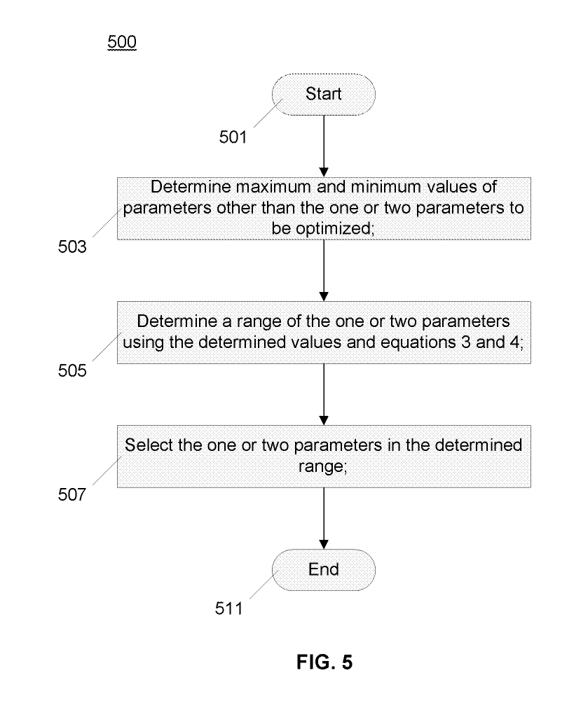

FIG. 5 illustrates a schematic diagram of a method 500 for determining one or two parameters of a sensor system for detecting a gaseous sample, where the sensor system comprises a hollow waveguide.

In block 501, the method 400 starts.

In block 503, determine maximum and minimum values for the parameters other than the one or two parameters to be optimized. Some embodiments of determining the maximum and minimum values for each parameter of a sensor system having a hollow waveguide have been discussed above.

In block 505, determine a range of the one or two parameters using the determined maximum and minimum values and equations 3 and 4. In this step, an area defined by lines defined by corresponding equations obtained using the determined maximum and minimum values and equations 3 and 4, is obtained.

In block 507, select the one or two parameters in the determined range. In this step, one may select a value for each of the one or two parameters in the area obtained in block 503. The method for selecting the values has been discussed above.

In block 509, the method 500 ends.

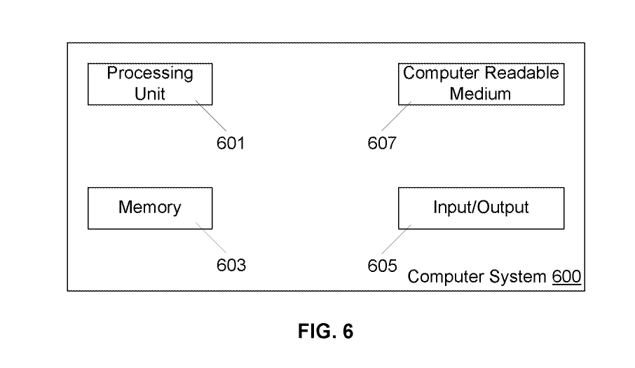

FIG. 6 illustrates a schematic diagram of a computer system 600. The computer system 600 comprises a processing unit 601 such as a CPU, a memory 603 such as a DDR memory, input/output devices 605 such as keyboard, mouse, and monitor, and a computer readable medium 607. The computer readable medium 607 contains computer executable instructions therein, when executed by the computer system 600, the computer system 600 will conduct the methods 400 or 500. The computer readable medium 607 may be a CD-ROM, a DVD-ROM, a flash memory device, a hard disk etc.

Applications of the sensor system disclosed herein. The sensor system disclosed in the present invention has many industrial applications for detecting and analyzing samples. For example, the system is able to measure the stable isotope ratios of ¹³C/¹²C for each chemical elutes from the GC, and it will find immediate applications in: 1) Geochemical/Geophysical studies: Oil and gas exploration and production, i.e. mud gas logging, can be use the data of ¹³C/¹²C for each hydrocarbon species, i.e. methane, ethane and propane, after conversion, to help identify the reservoir and conditions. Field deployed continuous measuring of these data is considered a big step forward, and this particular sensor system derived from claims 1-13 will be able to deliver such performance; 2) Agronomy and food industry: 13C/¹²C ratio for each hydrocarbon chemical contained in a given product may indicate the product origin, i.e. the “DNA” of the product. Field deployed measurements could be realized by the present invention, and may provide timely detection of artificial substitutes, 3) Atmospheric & environmental sensing: The present invention allows the provision of high temporal and high spatial resolution ¹³C/¹²C data, thus providing further constraint to carbon budget models. This allows a fuller understanding and account for carbon sources and sinks of all hydrocarbon species; 4) Planetary exploration: The present invention may be used in planetary exploration, especially Mars exploration; and 5) Medical diagnostics: Real time, continuous monitoring of trace molecule enables non-invasive breath diagnostics. For instance, the activity of Pylobacter Pylori (bacteria responsible of stomach ulcer) may be identified by the measurement of ¹³C/¹²C ratio of CO₂ in breath. ¹³C/¹²C ratio may also discriminate between a catabolic and anabolic state of living cells.

The sensor system is also able to accurately measure the Mid-IR spectrum for each chemical elutes from a GC, and such spectra helps positively identify chemicals much like GC-MS and in a complimentary way, it will find immediate applications in drug discovery and food safety: many drug and food species have the same mass or mass fragment features although their stereo structures are different and the resulting chemical/biological process will be totally different. One example is trans-fat and cis-fat, as they have the same mass but different stereo structure which are not distinguishable on GC-MS, but can have different Mid-IR spectra, and with the instrument in the present invention, field-deployed measurement of such stereo-isomers can be conducted.

We claim:

1. A sensor system for detecting at least one gaseous analyte with high resolution, the sensor system comprising:
a light source to generate a light beam,
a hollow waveguide which transmits the light beam and has a gas inlet and a gas outlet, wherein the gaseous analyte is introduced into the hollow waveguide through the gas inlet at an inlet pressure (P) and elutes through the gas outlet at a outlet pressure (Pₒᵤₜ), wherein P>Pₒᵤₜ; and
a detector which detect an absorption peak of the gaseous analyte in the presence of the light beam during transmitting;
where the hollow waveguide has a length (L) and an inner diameter (D);
where L and D substantially satisfy equation A and equation B;
$$\begin{matrix}\frac{L}{{D}^{4}} = \frac{P \cdot δ p \cdot π}{T \cdot μ \cdot Q \cdot {Z}_{m} \cdot R \cdot 128} & ( equation A ) \\ L \cdot {D}^{2} = \frac{Q \cdot t \cdot R \cdot T}{P} & ( equation B )\end{matrix}$$
where P is the inlet pressure applied to the gaseous analyte at the inlet of the hollow waveguide which is about 10˜200 torr, δp is the pressure difference between the inlet pressure and the outlet pressure of the hollow waveguide which is a value within the range of about 0.1%˜60% of P, t is the response time of the hollow waveguide, T is temperature of the gaseous sample in the hollow waveguide, p is the viscosity of the gaseous analyte, Q is the mole flow rate of the gaseous analyte, Zₘ is the compressibility of the gaseous analyte, R is the ideal gas constant equals to 8.31 Joule/Kelvin/Mole.

2. The sensor system of claim 1, wherein the light source is a laser source.

3. The sensor system of claim 2, wherein the laser source is a semiconductor laser source.

4. The sensor system of claim 3, wherein the semiconductor laser source is selected from quantum cascade laser sources and diode laser sources.

5. The sensor system of claim 1, wherein the wavelength of the light beam is in the Mid-Infrared region having a value of 2˜20 μm.

6. The sensor system of claim 1 further comprising a GC connected with the hollow waveguide, where during detection, the gaseous sample is first separated by the GC, and then is sent into the hollow waveguide operating at the appropriate pressure and dimensions as prescribed in claim 1.

7. The sensor system of claim 6, wherein Q is determined according to the output volumetric flow rate of the GC.

8. The sensor system of claim 7, wherein Q is a value within the range of Q_{GC}*70%˜Q_{GC}*130%, where Q_{GC} is the output volumetric flow rate of the GC.

9. The sensor system of claim 8, wherein t is determined in order to separate elute peaks from the GC output.

10. The sensor system of claim 1 further comprising a control loop for keeping P and Q stable.

11. The sensor system of claim 6 further comprising a combustion or pyrolysis reactor connected in between the GC and the inlet of the hollow waveguide, where the combustion or pyrolysis reactor converts the gaseous sample into smaller molecules.

12. The sensor system of claim 1 further comprising a temperature controlling device for keeping the temperature of the hollow waveguide stable using a feedback close loop mechanism.

13. The sensor system of claim 1 further comprising a light splitter which splits from the light beam a second light beam and a second detector to which the second light beam is directed, where the signal detected by the second detector is used to cancel noises result from fluctuation of the power of the light beam.

14. The sensor system of claim 1 wherein the gaseous analyte is a molecule having several isotopomers.

15. The sensor system of claim 1 wherein the isotope ratios of the particular elements are measured and calculated.

16. The sensor system of claim 14 wherein the molecule is CO₂ and the isotopes are ¹²C and ¹³C.

17. The sensor system of claim 14 wherein the molecule is H₂O and the isotopes are ¹H and ²H.

18. The sensor system of claim 1 wherein by is about 1%˜60% of P

19. A sensor system for detecting at least one gaseous analyte with high resolution, the sensor system comprising:
means for generating a light beam,
means for transmitting the light beam and the gaseous analyte with a gas inlet and a gas outlet,
means for applying an inlet pressure (P) to the gaseous analyte at the gas inlet,
means for generating a pressure difference (δp) between the gas inlet and the gas outlet wherein a outlet pressure at the gas outlet is lower than P, and
means for detecting an absorption peak of the gaseous analyte in the presence of the light beam during transmitting,
where the means for transmitting the light beam and the gaseous analyte has a length (L) and an inner diameter (D),
where L and D substantially satisfy equation A and equation B,
$$\begin{matrix}\frac{L}{{D}^{4}} = \frac{P \cdot δ p \cdot π}{T \cdot μ \cdot Q \cdot {Z}_{m} \cdot R \cdot 128} & ( equation A ) \\ L \cdot {D}^{2} = \frac{Q \cdot t \cdot R \cdot T}{P} & ( equation B )\end{matrix}$$
where P is about 10˜200 torr, by is about 0.1%˜60% of P, t is the response time of the means for transmitting the gaseous analyte, T is temperature of the gaseous sample in the hollow waveguide, μ is the viscosity of the gaseous analyte, Q is the mole flow rate of the gaseous analyte, Zₘ is the compressibility of the gaseous analyte, R is the ideal gas constant equals to 8.31 Joule/Kelvin/Mole.

20. A method for detecting a gaseous analyte with high resolution, comprising:
transmitting a light beam to a hollow waveguide having a gas inlet and a gas outlet;
introducing the gaseous analyte into the hollow waveguide through the gas inlet;
generating a pressure difference between an inlet pressure (P) applied to the gaseous analyte at the gas inlet and a outlet pressure at the gas outlet (Pₒᵤₜ), wherein P>Pₒᵤₜ, and
detecting an absorption peak of the gaseous analyte,
where the hollow waveguide has a length (L) and an inner diameter (D),
where L and D satisfy equation A and equation B,
$$\begin{matrix}\frac{L}{{D}^{4}} = \frac{P \cdot δ p \cdot π}{T \cdot μ \cdot Q \cdot {Z}_{m} \cdot R \cdot 128} & ( equation A ) \\ L \cdot {D}^{2} = \frac{Q \cdot t \cdot R \cdot T}{P} & ( equation B )\end{matrix}$$
where P is about 10˜200 torr, δp is P-Pₒᵤₜ and is about 0.1%˜60% of P, t is the response time of the hollow waveguide, T is the temperature of the gaseous analyte in the hollow waveguide, μ is the viscosity of the gaseous analyte, Q is the mole flow rate of the gaseous analyte, Zₘ is the compressibility of the gaseous analyte, R is the ideal gas constant equals to 8.31 Joule/Kelvin/Mole.

21. A method for determining length L and inside diameter D of a hollow waveguide of a sensor system for detecting a gaseous sample, where the hollow waveguide is to receive the gaseous sample and a light beam, where the sensor system further comprises a light source to generate the light beam, and a detector to detect an absorption peak of the gaseous sample, where the method comprises:
determining maximum and minimum values of the pressure at the entrance of the hollow waveguide P, the mole flow rate of the gaseous sample Q, the pressure difference between the entrance and the exit of the hollow waveguide δp, the response time of the hollow waveguide t, and the temperature of the gaseous sample T;
calculating a maximum and a minimum values for L/D⁴ which are indicated as V_{LD1} and V_{LD2}, respectively, using the determined maximum and minimum values according to the equation:
$$\frac{L}{{D}^{4}} = \frac{P \cdot δ p \cdot π}{T \cdot μ \cdot Q \cdot {Z}_{m} \cdot R \cdot 128}$$
calculating a maximum and a minimum values for L*D² which are indicated as V_{LD3} and V_{LD4}, respectively, using the determined maximum and minimum values according to the equation:
$$L \cdot {D}^{2} = \frac{Q \cdot t \cdot R \cdot T}{P}$$
and
selecting a point substantially falls in an area surrounded by four lines defined by equations L/D⁴=V_{LD1}, L/D⁴=V_{LD2}, L*D²=V_{LD3}, and L*D²=V_{LD4}, respectively,
where μ is the viscosity of the gaseous sample, Zₘ is the compressibility of the gaseous sample, T is temperature of the gaseous sample in the hollow waveguide R is the ideal gas constant equals to 8.31 Joule/Kelvin/Mole.

22. A computer program comprising computer executable instructions when executed by a computer instruct the computer to conduct the method of claim 17.

23. A computer readable medium containing the computer program of claim 18.

24. A method for determining one or two parameters of a sensor system for detecting a gaseous sample where the sensor system comprises a light source to generate a light beam, a hollow waveguide to receive the light beam and the gaseous sample, and a detector to detect the light signal output by the hollow waveguide, where the method comprises:
determining maximum and minimum values of the other parameters of the sensor systems,
determining a range of the one or two parameters using the determined maximum and minimum values and equations
$$\begin{matrix}\frac{L}{{D}^{4}} = \frac{P \cdot δ p \cdot π}{T \cdot μ \cdot Q \cdot {Z}_{m} \cdot R \cdot 128} and \\ L \cdot {D}^{2} = \frac{Q \cdot t \cdot R \cdot T}{P} ,\end{matrix}$$
and
selecting a value for each of the one or two parameters in the determined range.

25. A sensor system for detecting a gaseous sample, the sensor system comprising:
a light source to generate a light beam,
a hollow waveguide to receive the light beam and the gaseous sample, and
a detector to detect an absorption peak of the gaseous sample,
where the hollow waveguide has a length L and an inside diameter D,
where L and D fall in an area surrounded by four lines defined by the following four equations, respectively,
L/D⁴=V_{LD1}
L/D⁴=V_{LD2}
L*D²=V_{LD3}
L*D²=V_{LD4}
where V_{LD1} and V_{LD2} are maximum and minimum values of
$$\frac{P \cdot δ p \cdot π}{T \cdot μ \cdot Q \cdot {Z}_{m} \cdot R \cdot 128}$$
calculated using predetermined maximum and minimum values of P, δp, T, and Q, where P is the pressure of the entrance of the hollow waveguide, by is the pressure difference between the entrance and the exit of the hollow waveguide, T is temperature of the gaseous sample in the hollow waveguide, μ is the viscosity of the gaseous sample, Q is the flow rate of the gaseous sample, Zₘ is the compressibility of the gas sample, R is the ideal gas constant equals to 8.31 Joule/Kelvin/Mole.
where V_{LD3} and V_{LD4} are maximum and minimum values of
$$\frac{Q \cdot t \cdot R \cdot T}{P}$$
calculated using the predetermined maximum and minimum values of P and Q and predetermined maximum and minimum values of t, where t is the response time of the hollow waveguide.

26. A compound specific isotope analysis system that includes chromatographs and laser hollow-waveguide spectrometer for measuring isotope ratios of elutes.

27. A field deployable compound specific isotope analysis system that includes chromatographs and laser hollow-waveguide spectrometer for measuring carbon and/or hydrogen isotope ratios of hydrocarbons.
